(19) United States
(12) Patent Application Publication
(10) Pub. No.: US 2010/0182239 A1
(43) Pub. Date: Jul. 22, 2010

(54) System and Method for Testing a Portable Information Handling System

(76) Inventors: Zhi Hu Wang, Shanghai (CN); Wei Jian Zhu, Shanghai (CN)

Correspondence Address: HAMILTON & TERRILE, LLP, P.O. BOX 203518, AUSTIN, TX, 78720, US

(21) Appl. No.: 12/356,129

(22) Filed: Jan. 20, 2009

(51) Int. Cl. G06F 3/02

(52) U.S. Cl. 345/168

(57) ABSTRACT

Portable information handling system keyboard functionality is tested by an external keyboard configured with portable keyboard functionality and interfaced through a peripheral interface, such as a USB port and cable or a wireless interface. For example, the test keyboard has a portable keyboard functionality that matches the keyboard to be integrated into the portable information handling system, such as a touchstick, mousepad, and key combinations that perform portable information handling system functions.

### BACKGROUND OF THE INVENTION

1. Field of the Invention

The present invention relates in general to the field of testing information handling systems, and more particularly to a system and method for testing keyboard interactions with a portable information handling system.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Broadly speaking, information handling systems are divided into two types, stationary systems also known as desktops and portable systems also known as laptops. Desktop systems are generally too bulky, heavy and awkward for an end user to carry and use in different locations. In addition, desktop information handling systems typically operate by interacting with a number of peripheral input/output (I/O) devices, such as a display interfaced with a DVI or other cable, a keyboard interfaced with a Universal Serial Bus (USB) cable or wireless connection, a mouse interfaced with a USB cable or wireless connection, and speakers. In contrast, portable information handling systems typically have a smaller and less bulky footprint so that an end user can carry the system to different locations for portable operability. To support portable operations, portable information handling systems have an integrated battery, an integrated display and an integrated keyboard. Typically, portable information handling systems also have a variety of peripheral ports so that an end user can interface with the system through external peripheral devices. For example, portable information handling systems often include USB ports that interact with external keyboards and mice, and video ports that interact with external displays. Portable information handling systems also sometimes include a docking station connector so that the system can connect to a docking station that supports external peripheral devices. Another way to interface external peripherals with a portable information handling system is through a wireless connection, such as a Bluetooth wireless connection.

One design consideration for portable information handling systems is the tradeoff that occurs between system performance and system footprint. Larger portable information handling systems usually have greater processing capability because more room exists in the system housing to include processing components. Smaller housings have less room for processing components and are often more difficult to cool. Although smaller sized portable information handling systems typically have less processing capability, end users who travel frequently tend to favor smaller-sized housings due to their convenience. One difficulty with portable systems, especially smaller-sized systems, is that the housing footprint is typically too small to support a full-sized keyboard. Often, keyboards used as external peripherals to desktop information handling systems have standardized letter key layouts plus a number pad. In order to save space, portable information handling system integrated keyboards typically have a dual function key, usually labeled “Fn” in blue letters, which allows other keys of the keyboard to perform dual functions. For example, if the dual function “Fn” key is pressed, the letters m, j, k, l, u, i, and o become the numbers 0 through 6 respectively. Other dual functions include using arrow keys to adjust display brightness, using the F8 key to switch displays, using page up and page down keys to adjust speaker volume, etc . . . . Although the dual function key on a portable keyboard helps reduce keyboard footprint, keyboard functionality is difficult to test. In order to test the system's interaction with the dual function key, a portable system keyboard generally has to be installed at the housing. If a problem is uncovered during testing, the system keyboard must then be disassembled to address the problem, increasing test time.

### SUMMARY OF THE INVENTION

Therefore a need has arisen for a system and method which tests keyboard interaction with a portable information handling system before integration of the keyboard into the system housing.

In accordance with the present invention, a system and method are provided which substantially reduce the disadvantages and problems associated with previous methods and systems for testing keyboard interaction. Portable keyboard functionality of a portable information handling system is tested by interfacing the portable information handling system with an external keyboard that supports the portable functionality.

More specifically, processing components are assembled into a portable housing configured to accept an integrated keyboard with portable keyboard functionality. Before integration of the keyboard, an external keyboard having portable keyboard functionality that matches the integrated keyboard is interfaced with the processing components, such as through a USB or wireless interface. The portable keyboard functionality is tested with the external keyboard, such as touch stick functionality, mousepad functionality and key combination functionalities that are unique to portable information handling systems. If the portable keyboard functionality tests operational, the external keyboard is decoupled from the portable information handling system and the integrated keyboard is assembled into the portable housing.

The present invention provides a number of important technical advantages. One example of an important technical advantage is that a keyboard having a portable dual function configuration interfaces with a portable information handling system to allow testing of the information handling system without having to assemble the keyboard into the portable housing. The testing keyboard allows testing of all functions available through the integrated keyboard but without requiring installation of an integrated keyboard. Thus, portable information handling system functionality is thoroughly tested in less time, especially where testing indicates a failure that requires removal of the keyboard to correct.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a portable information handling system interfaced with an external keyboard having portable functionality for testing; and

FIG. 2 depicts a flow diagram of a process for testing a portable information handling systems portable functionality with an external keyboard.

### DETAILED DESCRIPTION

Testing portable information handling system keyboard functionality with an external keyboard reduces built time where faults exist. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

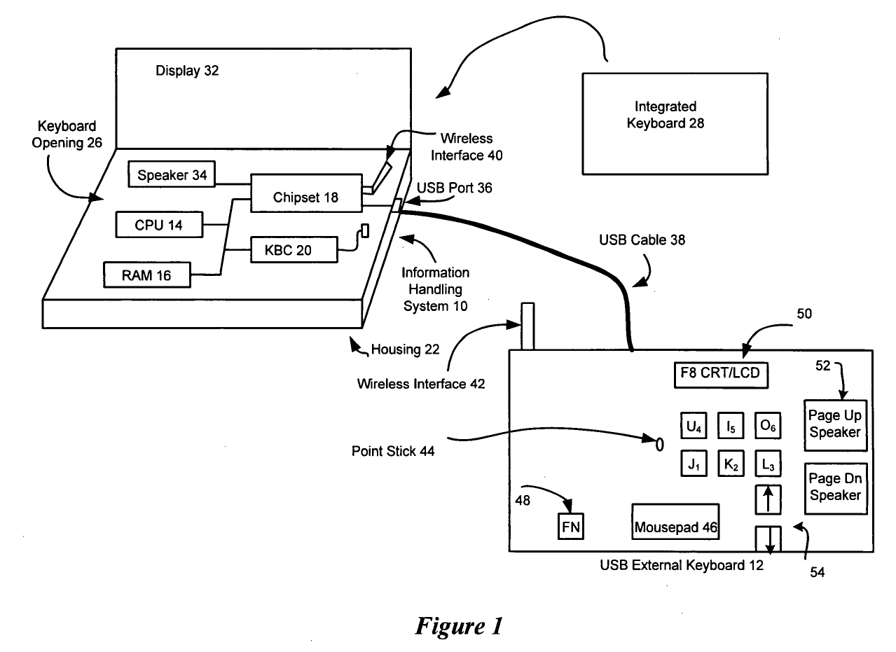

Referring now to FIG. 1, a block diagram depicts a portable information handling system 10 interfaced with an external keyboard 12 having portable functionality for testing. Information handling system 10 includes a plurality of processing components that cooperate to process information, such as a CPU 14, RAM 16, a chipset 18 and a keyboard controller 20. The processing components are built into a portable housing 22 having a rotationally coupled lid 24 and a keyboard opening 26 into which an integrated keyboard 28 is built to enclose the processing components. Integrated keyboard 28 connects to an integrated keyboard connector 30 to communicate with the processing components through a keyboard controller 20, also known as an embedded controller. Integrated keyboard 28 includes a number of portable keyboard functionalities that are unique to portable information handling systems, such as key combinations to control brightness of an integrated display 32, key combinations to control volume of an integrated speaker 34, keyboard combinations to select key values and integrated pointstick and mousepad devices.

In order to test portable keyboard functionality of portable information handling system 10, an external keyboard 12 interfaces with information handling system 10, such as through a USB port 36 and USB cable 38 or a wireless interface 40 and 42, such as a Bluetooth wireless interface. In an alternative embodiment, external keyboard 12 interfaces with integrated keyboard connector 30. External keyboard 12 includes portable keyboard functionality to support testing of the portable keyboard functionality at information handling system 10. In one embodiment, the portable keyboard functionality of external keyboard 12 is matched to the portable keyboard functionality configured in integrated keyboard 28 that will be built into portable information handling system 10. For example, a point stick 44 and mousepad 46 are included in external keyboard 12 to test interaction of the processing components with a point stick and mousepad before assembly of integrated keyboard 28 into portable housing 22. As another example, an function key 48 is provided in external keyboard 12 to test various selectable key values and key combinations. For instance, selection of function key 48 changes the values of the “j”, “k”, “l”, “u”, “I” and “o” keys respectively to number pad values of 1, 2, 3, 4, 5 and 6 respectively. Selection of function key 48 also provides key combinations to support control of devices integrated in portable information handling system 10. For instance, selection of function key 48 with F8 key 50 selects a display for presentation of information; with “page up” and “page down” keys 52 adjusts speaker volume; and with up and down arrow keys 54 adjusts brightness at integrated display 32. Once portable functionality testing is completed with external keyboard 12, integrated keyboard 28 is built into housing 22.

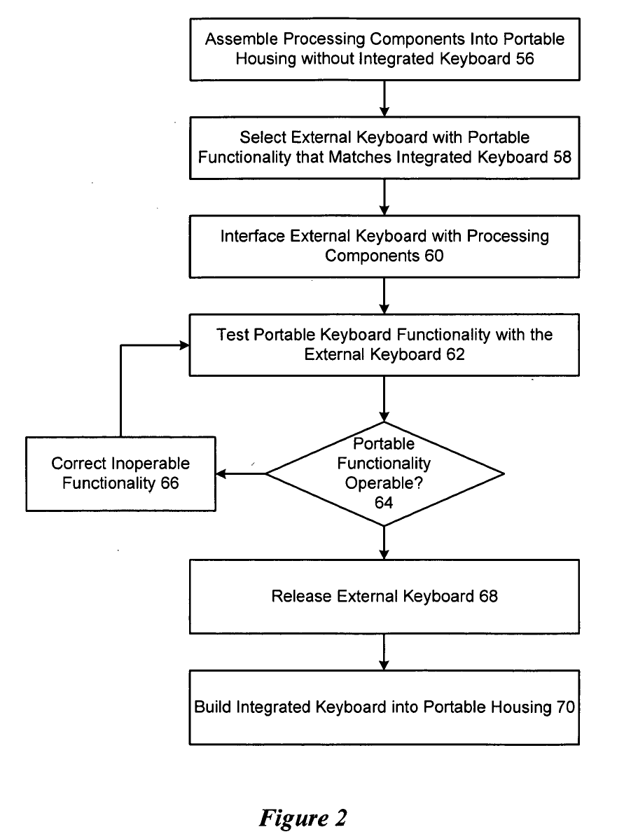

Referring now to FIG. 2, a flow diagram depicts a process for testing a portable information handling system's portable keyboard functionality with an external keyboard. The process begins at step 56 with assembly of processing components into a portable housing without assembly of an integrated keyboard over the processing components. At step 58, an external keyboard is selected with portable functionality that matches the portable functionality of the integrated keyboard to be assembled into the portable housing after testing. At step 60, the selected external keyboard is interfaced with the processing components, such as with a USB interface or a Bluetooth wireless interface. At step 62, portable keyboard functionality is tested at the information handling system with interactions through the external keyboard. At step 64 a determination is made of whether the portable functionality is operable. If not, the process continues to step 66 to correct the inoperable functionality and returns to step 62 to re-test the portable functionality. If the portable functionality tests operable at step 64, the process continues to step 68 to release the external keyboard and step 70 complete building of the integrated keyboard into the portable housing.

Although the present invention has been described in detail, it should be understood that various changes, substitutions and alterations can be made hereto without departing from the spirit and scope of the invention as defined by the appended claims.

What is claimed is:

1. An information handling system comprising:
a portable housing having an opening adapted to accept an integrated keyboard;
processing components disposed in the portable housing and operable to process information, the processing components further operable to communicate with the integrated keyboard through an internal bus, the integrated keyboard having a portable configuration with portable functionality;
at least one peripheral connector disposed in the housing and operable to interface an external keyboard with the processing components; and
an external keyboard having a peripheral cable adapted to communicatively couple with the peripheral connector, the external keyboard operable to communicate with the processing components to test the portable functionality.

2. The information handling system of claim 1 wherein the peripheral connector comprises a USB connector.

3. The information handling system of claim 1 wherein the portable functionality comprises a point stick disposed in the external keyboard.

4. The information handling system of claim 1 wherein the portable functionality comprises a mousepad disposed in the keyboard.

5. The information handling system of claim 1 wherein the portable functionality comprises a function key operable to convert predetermined letter key inputs into predetermined number key inputs.

6. The information handling system of claim 5 wherein the predetermined letter key comprises a “j” key and the predetermined number key comprises a “1” key.

7. The information handling system of claim 1 wherein the portable functionality comprises a key combination to adjust display brightness.

8. The information handling system of claim 1 wherein the portable functionality comprises a key combination to select one or more displays to present information.

9. The information handling system of claim 1 wherein the portable functionality comprises a key combination to adjust integrated speaker volume.

10. A method for testing a portable information handling system having an integrated keyboard, the method comprising:
assembling processing components into a portable housing, the processing components operable to process information;
interfacing an external keyboard with the processing components; and
testing portable keyboard functionality with the external keyboard.

11. The method of claim 10 further comprising:
determining the portable keyboard functionality is operable; and
integrating a keyboard into the portable housing.

12. The method of claim 10 wherein interfacing an external keyboard further comprises interfacing a peripheral cable of the keyboard with a peripheral port of the information handling system.

13. The method of claim 12 wherein the peripheral cable comprise a USB cable and the peripheral port comprises a USB port.

14. The method of claim 10 wherein interfacing an external keyboard further comprises establishing a wireless interface between a wireless device of the keyboard and a wireless device of the information handling system.

15. The method of claim 10 wherein the portable functionality comprises a point stick disposed in the external keyboard.

16. The method of claim 10 wherein the portable functionality comprises a mousepad disposed in the keyboard.

17. The method of claim 10 wherein the portable functionality comprises a function key operable to convert predetermined letter key inputs into predetermined number key inputs.

18. The method of claim 17 wherein the predetermined letter key comprises a “j” key and the predetermined number key comprises a “1” key.

19. The method of claim 10 wherein the portable functionality comprises a key combination to adjust display brightness.

20. The method of claim 10 wherein the portable functionality comprises a key combination to select one or more displays to present information.
